(19) United States
(12) Patent Application Publication
(10) Pub. No.: US 2007/0218919 A1
(43) Pub. Date: Sep. 20, 2007

(54) Information broadcast for wireless cellular networks

(76) Inventors: Esref Salih Ozulkulu, Southport, CT (US); Bekir Sami Serbetcioglu, Caddebostan (TR); Ilhan Bagoren, Westport, CT (US); Hakan Akarcali, Umraniye (TR)

Correspondence Address: GORDON & JACOBSON, P.C., 60 LONG RIDGE ROAD, SUITE 407, STAMFORD, CT, 06902, US

(21) Appl. No.: 11/375,269

(22) Filed: Mar. 14, 2006

(51) Int. Cl. H04Q 7/20

(52) U.S. Cl. 455/456.1; 455/566

(57) ABSTRACT

A method and system for wireless broadcast mode communication of location-specific information to mobile units of a cellular network. Each respective mobile unit automatically updates a predetermined display area, preferably in the main display window of the respective mobile unit, in order to visually convey the location-specific information broadcasted thereto.

### BACKGROUND OF THE INVENTION

1. Field of the Invention

This invention relates broadly to communication systems. More particularly, this invention relates to broadcasting information to mobile users over wireless cellular networks.

2. State of the Art

Existing cellular communication networks are designed with a network topology that is exclusively point to point in nature. This paradigm represents the historical view of cellular communications as a wireless equivalent of traditional wire-line telephone communication networks, which serve to interconnect a calling party with a called party. The need to concurrently serve many voice subscribers with the limited bandwidth available in cellular communication networks has also prevented the provision of wide bandwidth communication services to these subscribers.

These existing systems are largely static in their operation, with each cell providing point to point communications to a population of subscribers who reside in or roam into the predefined service area of the cell. Thus, there is an absence of a capability to provide advanced communication services that allows for communication of location-specific information to subscribers that are located within a coverage region corresponding to the location-specific information. In this manner, existing systems do not allow for communication of location-specific information to its target audience in a real time manner.

### SUMMARY OF THE INVENTION

The above described problems are solved and a technical advance achieved by a method and system for information broadcast in a cellular network which employs a plurality of base stations each providing bidirectional wireless communication with mobile units located within a respective coverage area adjacent thereto. Location-specific information is received at an interface associated with a given base station, and communicated from the given base station to mobile units served by the given base station in a wireless broadcast mode of operation. The mobile units served by the given base station receive the location-specific information. Each respective mobile unit updates a predetermined display area (preferably, a portion of the main display window) on the mobile unit in order to visually convey the location-specific information. The location-specific information communicated to the base station interface(s) can be dynamically updated. Moreover, the location-specific information can be communicated to a group of base station interfaces of varying granularity for different geographical coverage. The location-specific information is preferably generated by a remotely-located content source/server and communicated to the group of base station interfaces over at least one communication network (e.g., IP Network such as the Internet) therebetween.

In one embodiment, the location-specific information is generated in accordance with results of a voting contest (e.g., it relates to a winner of the voting contest for a particular geographic region covered by the given base station).

In another embodiment, the location-specific information is generated in accordance with results of an action associated with a geographic region covered by one or more base stations of the network (e.g., it is location-specific advertising information supplied by a winning bidder of the auction).

Additional objects and advantages of the invention will become apparent to those skilled in the art upon reference to the detailed description taken in conjunction with the provided figures.

### BRIEF DESCRIPTION OF THE DRAWINGS

FIG. 1 is a schematic diagram of an embodiment of an information broadcast system in accordance with the present invention.

FIG. 2 is a high level functional block diagram of a mobile unit.

FIG. 3 is a schematic illustration of a display screen displayed on the display device of the mobile unit of FIG. 2 in accordance with the present invention.

### DETAILED DESCRIPTION OF THE PREFERRED EMBODIMENTS

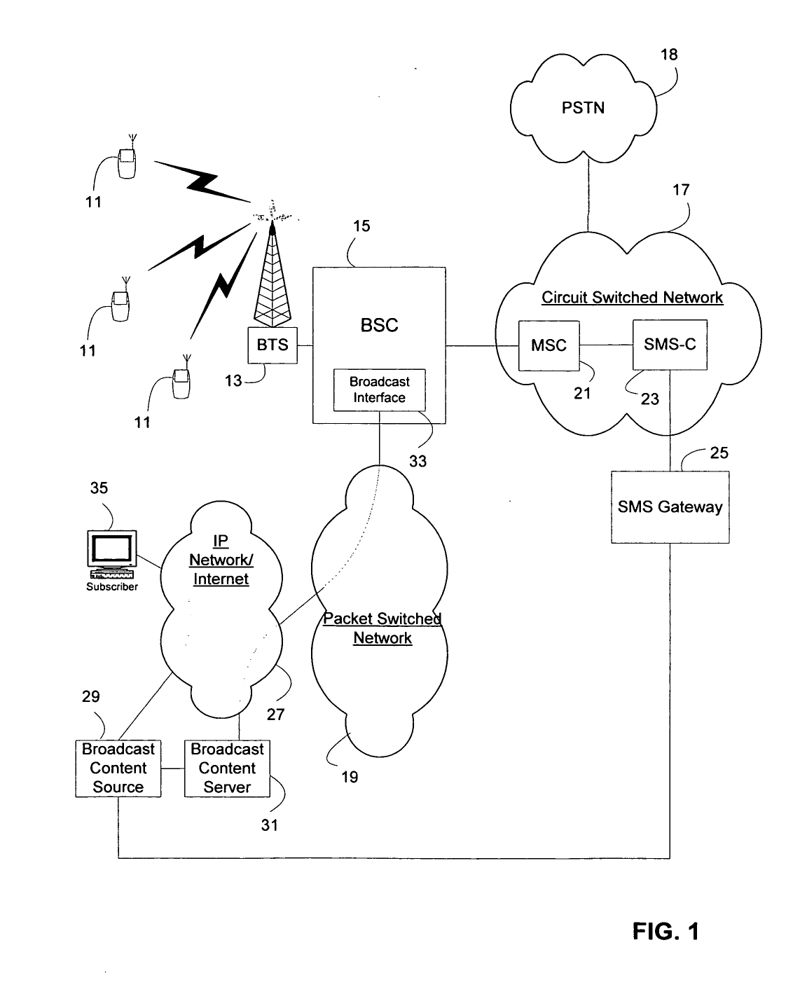

Turning now to FIG. 1, there is shown a schematic diagram of an exemplary information broadcast system over a cellular wireless communication network. Mobile units 11 communicate over wireless directional communication links to base stations 13 (one shown). The base stations 13 are operably coupled to base station controllers 15 (one shown), which are responsible for radio resource allocation to the mobile units 11, frequency administration and handover between base stations 13. The base station controller function may be physically located within a base station 13 itself. The base station controllers 15 interface to a circuit switched network 17 and a packet switched network 19. Circuit switched traffic (e.g., voice calls, SMS messages) is routed over the circuit switched network 17. Packet switched traffic (e.g., GPRS data) is routed over the packet switched network 19. The circuit switched network 17 includes a mobile switching center (MSC) 21 and a SMS center (SMS-C) 23. The MSC 21 provides the signaling functions that are necessary to establish voice calls to and from the mobile units 11. Generally, the MSC 21 connects the circuit switched network 17 to the public switched telephone network 18 and manages and routes voice traffic into and out of the circuit switch network 17. The SMS-C 23 functions as a centralized store-and-forward device that accepts SMS messages and buffers the received SMS messages until a suitable delivery time (i.e., the cell phone is powered on and the location known). The SMS-C 23 also provides an interface in accordance with a communication protocol (e.g., UCP, SMPP, Sema OIS, CIMD2) that allows for routing of SMS messages to and from other cell networks and to and from other external SMS processing devices (e.g., the SMS gateway 25). Preferably, the external SMS processing devices are connected to the SMS-C 23 over a wide area network such as the Internet.

The mobile units 11 can be any of a number of communication devices including cellular handset devices, personal digital assistants, personal computers, and the like. Each base station 13 includes at least one antenna and a group of one or more radio transmitter-receiver pairs. Each transmitter-receiver pair operates on a pair of radio frequencies to create a communication channel: one frequency to transmit radio signals to a mobile unit 11 and the other frequency to receive radio signals from the mobile unit 11.

Each base station 13 defines a cell of the network, which is a predetermined volume of space radially arranged around its antenna. In order to prevent the radio signals transmitted from one base station from interfering with radio signals transmitted from an adjacent base station, the transmitter frequencies for adjacent base stations are selected to be different so that there is sufficient frequency separation between adjacent transmitter frequencies. In order to reuse the same frequencies, the cellular telecommunication industry has developed a small but finite number of transmitter frequencies and allocation patterns that ensure that adjacent cell sites do not operate on the same frequency. When a mobile unit 11 initiates a call connection, control signals transmitted from the local base station 13 cause the frequency agile transponder in the mobile unit 11 to operate at the frequency of operation designated for that particular base station. As the mobile unit 11 moves from one cell to another, the call connection is handed off to the successive base station and the frequency agile transponder in the mobile unit 11 adjusts its frequency of operation to correspond to the frequency of operation of the base station 13 located in the cell in which the mobile unit 11 is presently operational.

There are numerous technologies that can be used to implement the cellular communication network and these include both digital and analog paradigms, with the digital apparatus representing the more recent of the two technologies. Furthermore, the frequency spectrum is allocated for different cellular communication systems, with the personal communication system (PCS) systems being located in the 1.9 GHz region of the spectrum while traditional cellular systems are located in the 800 MHZ region of the spectrum. Third generation cellular systems such as Wideband Code Division Multiple Access (W-CDMA) systems employ higher frequency bands. The access methods used in cellular communication systems include Code Division Multiple Access (CDMA) that uses orthogonal codes to implement communication channels, Time Division Multiple Access (TDMA) which uses time division multiplexing of a frequency to implement communication channels and Frequency Division Multiple Access (FDMA) which uses separate frequencies to implement communication channels, as well as combinations of these technologies. These concepts are well known in the field of cellular communications and various ones of these can be used to implement the ubiquitous wireless subscriber device of the present invention. These technologies are not limitations to the system that is described herein, since a novel system concept is disclosed, not a specific technologically limited implementation of an existing system concept.

In accordance with the present invention, a Broadcast Content Source 29 cooperates with a Broadcast Content Server 31 to generate location-specific information (information that is targeted to mobile users that are generally located within a specific coverage area of one or more base stations 13 of the network) and distribute such location-specific information to the corresponding base station(s) 13. In the exemplary embodiment shown, the Broadcast Content Server 31 communicates the location-specific information to the base station controllers 15 of the network over the IP network 27 and the packet switched network 19. This enables the Broadcast Content Source 29 and Broadcast Content Server 31 to be located outside the cellular network yet interface to the base stations 13 of the network. However, alternate architectures are possible and different communication mechanisms can be used. For example, the Broadcast Content Server 31 can be integrated into the cellular network and interface to the base station controllers 13 over the packet switched network 19. In this architecture, the Broadcast Content Source 29 can be located outside the cellular network yet interface to and Broadcast Content Server 31 over the IP Network 27.

Each base station controller 15 includes broadcast interface functionality 33 that receives the location-specific information supplied thereto from the Broadcast Content Server 31 and that cooperates with the transmitter of the base station 13 coupled thereto to communicate such location-specific information to a plurality of mobile units 11 serviced by the base station 13. The location-specific information is communication from the base station 13 to the plurality of mobile units 11 in a broadcast mode of operation wherein the plurality of mobile units 11 concurrently receive such location-specific information.

As described above, the mobile units 11 are capable of receiving the location-specific information communicated thereto. This location-specific information is simultaneously delivered to multiple mobile units 11 that are serviced by a given base station 13 (or group of base stations 13). This location-specific information can be text data (text information, stock quotes and the like) and/or multimedia information such as images (pictures, a bit-map graphic, icons and the like), audio data (e.g., music, radio shows, news and the like), or video data (MTV-like videos, news, live traffic cams and the like).

The content delivery region for the location-specific information is dictated by the granularity of the cells of the cellular network and can range from a national coverage region (e.g., delivered to base station interfaces located across multiple states/regions of a country), a regional coverage region (e.g., delivered to base station interfaces located across one or more states/regions of a country), a county coverage region (e.g., delivered to base station interfaces located across one or more counties of a state/region), a town coverage region (e.g., delivered to base station interface(s) located across one or more towns of a region), a neighborhood coverage region (e.g., delivered to base station interface(s) located across one or more neighborhoods) or a site coverage region (e.g., delivered to base station interface(s) located across one or more sites such as a particular building, stadium or other venue), and/or any combination of the above. The content delivery region and location-specific information can be dynamically updated over time as required.

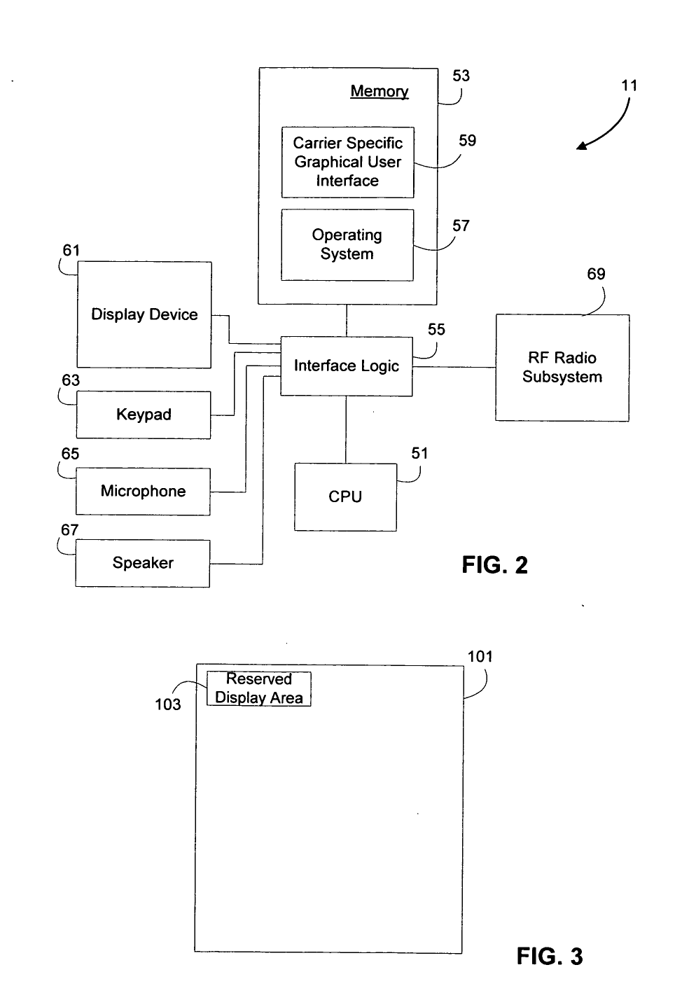

FIG. 2 illustrates, in block diagram form, the architecture of an exemplary embodiment of a given mobile unit 11, including a central processor unit 51 that is interfaced to memory 53 by interface logic 55. The memory 53, which is typically realized by persistent memory (such as one or more ROM memory modules and/or one or more flash memory modules) as well as non-persistent memory (such as one or more DRAM modules), stores an operating system 57 (e.g., Symbian operating system, Palm operating system, or Windows Mobile operating system) as well as a carrier-specific graphical user interface 59. The central processor unit 51 also interfaces to a display device 61 (e.g., a small-size liquid crystal display panel), a keypad 63 and/or other user input device (e.g., a touch screen disposed on the display device 61), a microphone 65 for voice input, and a speaker 67 for voice/audio output. The central processor unit 51 interfaces to a RF radio subsystem 69 that is equipped with transmitter and receiver circuitry that interface to an antenna, which is typically mounted on the exterior of the mobile unit. The transmitter and receiver circuitry cooperate with the antenna to communicate with the base stations of the cellular network over the air interface therebetween.

The operating system 57 is executed by the central processing unit 51 and manages the operation of the components of the mobile unit 11, including displaying the carrier-specific graphical user interface 59 on the display device 61, cooperating with the user input device(s) (e.g. keypad 63, microphone 65) to provide for user input in accordance with the carrier-specific graphical user interface 59, controlling (e.g., invoking, terminating) functions carried out by components of the mobile unit 11 in accordance with user input, and cooperating with the output devices (e.g., display device 61, speaker 67) of the mobile unit 11 to communicate information delivered to the mobile unit 11 by RF communication between the RF radio subsystem 69 and the base stations 13 of the network.

For example, the execution of the operating system 57 supplies voice data (in digital form) that is derived from voice information received by the RF radio subsystem 69 to digital-to-analog conversion circuitry that is part of the interface logic 55 for conversion into analog form. This analog voice signal is then supplied to speaker 67 for generation as audible voice signals for output to the user. In another example, the execution of the operating system 57 supplies audio data (in digital form) that is derived from audio information received by the RF radio subsystem 69 to digital-to-analog conversion circuitry that is part of the interface logic 55 for conversion into analog form. This analog audio signal is then supplied to speaker 67 for generation as audible audio signals for output to the user. In yet another example, the execution of the operating system 57 updates the carrier-specific graphical user interface 59 displayed on the display device 61 to convey text information and/or multimedia information (e.g., images or videos) which is derived from information delivered by RF communication between the RF radio subsystem 69 and the base stations 13 of the network.

The carrier-specific graphical user interface 59 of the mobile unit includes a set of display windows or screens organized in a hierarchical fashion, with the primary or main display window displayed upon start-up of the mobile unit 11. User interaction with the main display window opens up a corresponding secondary display window.

The display windows of the interface 59 includes areas that can be logically classified into the following groups:
i) Group I—Manufacturer-reserved display areas
   the Group I display areas convey information that is provided by the manufacturer; examples of such Group I display areas include reserved areas for displaying the name of the manufacturer of the mobile unit (e.g., Motorola).
ii) Group II—Carrier-reserved display areas
   the Group II display areas convey information that is provided by the carrier (wireless service provider) of the network; examples of such Group II display areas include reserved areas for displaying the name of the carrier (e.g., t-Mobile).
iii) Group III—Subscriber-reserved display area
   the Group III display area convey information that is provided by the end user subscriber; examples include reserved areas for displaying contact names, associated telephone numbers and possibly associated addresses (including home/work addresses, email addresses, etc).
      Note that some of the Group I and II display areas can be reconfigured by the end user subscriber to be hidden (not displayed on the display device).

In the preferred embodiment as shown in FIG. 3, the primary display window 101 of the interface 59 includes at least one Group II display area 103 that is reserved for displaying location-specific information delivered by broadcast mode communication between the base stations 13 of the network and the RF radio subsystem 69 of the mobile unit 11. The operating system 57 executing on the central processor unit 51 monitors the information communicated by the broadcast mode methodology between the base stations 13 of the network and the RF radio subsystem 69 of the mobile unit 11 and updates the reserved display area 103 to convey the location-specific information as it is received. In this manner, the reserved display area 103 can be updated dynamically with location-specific information. Advantageously, such communication can be an additional source of revenue for the carrier.

Note that the broadcast mode communication of the location-specific information between the base stations 13 of the network and the mobile units 11 can be carried out by particular methodologies that depend upon the underlying air interface between the base stations and the mobile units.

For example, CDMA networks employ a Forward Channel between the base stations of the network and the mobile units that is divided into a plurality of well known units including a Pilot segment, a Synchronization (Synch) segment, a Paging segment and Traffic segments. The Paging and Traffic segments are further divided into a plurality of Paging channels Ch1-Ch7 and a plurality of Traffic channels Ch1-Ch55, respectively. In order to segregate these channels, each channel is assigned a unique one of 64 Walsh codes, from W=0 to W-64. In this exemplary architecture, one or more of these Traffic channels and/or one or more of these Paging channels can be designated for carrying out the broadcast mode communication of location-specific information between the base stations 13 and the mobile units 11 of the network. Alternatively, one or more other communication channels between the base stations and the mobile units of the network can be used for carrying out the broadcast mode communication of the location-specific information.

In other examples, GSM networks and W-CDMA networks employ logical channels that carry signaling data and user data. The data incorporated into the logical channels are mapped onto physical channels. The logical channels that carry signaling data between the base stations and the mobile units of the network include a Broadcast Control Channel (BCCH), a Synchronization Channel (SCH), a Frequency Correction Channel (FCCH), a Random Access Channel (RACH), an Access Grant Channel (AGCH), a Paging Channel (PCH), a Standalone Dedicated Control Channel (SDCCH), a Slow Associated Control Channel (SACCH), and a Fast Associated Control Channel (FACCH). In this exemplary architecture, one or more of these logical channels can be designated for carrying out the broadcast mode communication of location-specific information between the base stations 13 and the mobile units 11 of the network. Alternatively, one or more other communication channels between the base stations and the mobile units of the network can be used for carrying out the broadcast mode communication of the location-specific information.

The cellular-based information broadcast system described above can be utilized to distribute a wide range of location-specific information.

In one application, subscribers can vote as part of a particular contest or promotion, such as their favorite singer (e.g., American Idol) or their favorite major league baseball team. Such voting is preferably accomplished by Short Message Service (SMS) messages that are routed by the SMS-C 23 of the network to the SMS Gateway 25. The SMS Gateway 25 forwards the SMS messages (or the vote information contained therein) to the Broadcast Content Source 29, which tallies the vote information. Such tallying can be accomplished at the end of a voting window and possible periodically (e.g., hourly, daily, weekly) during the voting window. The tallied results are used to identify the winner (i.e., the contest participant that received the majority or plurality of votes) over a defined number of geographical regions covered by the base stations of the network. For each geographical region, information corresponding to the winner (e.g., the name, logo and other insignia of the baseball team winning the majority votes in a given geographical region) is generated by the Broadcast Content Source 29 and communicated by the Broadcast Content Server 31 to the broadcast interface(s) 33 that serve the given geographical region. Such communication can be directed to multiple broadcast interfaces typically for a national/regional/state/county/town coverage region, or can be directed to a single broadcast interface typically for a neighborhood/site coverage region. Each broadcast interface 33 cooperates with the base station 13 coupled thereto to carry out broadcast mode communication of the received location-specific information to the mobile units served by the base station. Upon receipt at the mobile units 11, the carrier-specific graphical user interface 59 of each mobile unit 11 is updated to display the location-specific information in the reserved display area 103 of the display window of the mobile unit 11. Note that the voting can be accomplished by other mechanisms, such as wireless application protocol (WAP) sessions, multimedia messaging service (MMS) messages, user interaction with web pages served by a web server, user interaction with an interactive voice response (IVR) system, or by other means.

In another application, the reserved display area 103 of the primary display window 101 is used to display location-specific advertising information delivered by broadcast communication to the mobile units. In this application, the Broadcast Content Source 29 hosts auctions pertaining to geographical regions covered by the base stations of the network. Subscribers 35 can submit bids for the auctions. For a given auction, the subscriber submitting the winning bid supplies advertising information to the Broadcast Content Source 29, which is communicated by the Broadcast Content Server 31 to the broadcast interface(s) 33 serving the geographical region for the given auction. Such communication can be directed to multiple broadcast interfaces typically for a national/regional/state/county/town coverage region, or can be directed to a single broadcast interface typically for a neighborhood/site coverage region. Each broadcast interface 33 cooperates with the base station 13 coupled thereto to carry out broadcast mode communication of the received location-specific advertising information to the mobile units served by the base station. Upon receipt at the mobile units 11, the carrier-specific graphical user interface 59 of each mobile unit 11 is updated to display the location-specific advertising information in the reserved display area 103 of the display window of the mobile unit 11. Advantageously, such advertising can be an additional source of revenue for the carrier.

There have been described and illustrated herein several embodiments of a cellular-based information broadcast system and methods of operating such systems. While particular embodiments of the invention have been described, it is not intended that the invention be limited thereto, as it is intended that the invention be as broad in scope as the art will allow and that the specification be read likewise. For example, it is contemplated that other display areas of the mobile unit's graphical user interface can be reserved for displaying the location-specific information broadcast thereto. It will therefore be appreciated by those skilled in the art that yet other modifications could be made to the provided invention without deviating from its spirit and scope as claimed.

What is claimed is:

1. A method of communicating information to mobile units of a cellular network comprising:
receiving location-specific information at an interface associated with a given base station;
communicating said location-specific information from the given base station to mobile units served by the given base station in a wireless broadcast mode of operation; and
for each respective mobile unit served by the given base station, upon receipt of said location-specific information communicated from the given base station, updating a predetermined display area of a display window on the respective mobile unit in order to visually convey said location-specific information.

2. A method according to claim 1, further comprising:
dynamically updating location-specific information communicated to the interface associated with said given base station.

3. A method according to claim 1, further comprising:
communicating said location-specific information to a group of interfaces associated with respective base stations, wherein each interface of the group receives said location-specific information and effectuates communication of said location-specific information from the given base station associated therewith to mobile units served by the given base station in a wireless broadcast mode of operation.

4. A method according to claim 1, wherein:
each respective mobile unit employs a graphical user interface comprising a logically organized hierarchy of display windows, said predetermined display area being part of said hierarchy of display windows.

5. A method according to claim 4, wherein:
said hierarchy of display windows includes a main display window that is displayed at start-up, said predetermined display area being part of said main display window.

6. A method according to claim 1, wherein:
said given base station communicates with mobile units served by the given base station over a plurality of wireless communication channels, wherein at least one of said wireless communication channels is assigned for communicating said location-specific information from the given base station to mobile units served by the given base station in the wireless broadcast mode of operation.

7. A method according to claim 6, wherein:
said given base station employs one at least one of (i) code division multiple access methodology that uses orthogonal codes to implement said plurality of wireless communication channels, (ii) time division multiple access methodology that uses time division multiplexing of a frequency to implement said plurality of wireless communication channels, and (iii) frequency division multiple access methodology which uses separate frequencies to implement said plurality of wireless communication channels.

8. A method according to claim 1, further comprising:
generating said location-specific information at a content source; and
communicating said location-specific information from the content source to the interface over at least one communication network therebetween.

9. A method according to claim 8, wherein:
said communication network comprises an IP network.

10. A method according to claim 9, wherein:
said IP network includes the Internet.

11. A method according to claim 8, wherein:
said generating said location-specific information comprises generating said location-specific information in accordance with results of a voting contest.

12. A method according to claim 11, wherein:
said location-specific information relates to a winner of the voting contest for a particular geographic region covered by the given base station.

13. A method according to claim 10, wherein:
said generating said location-specific information comprises generating said location-specific information in accordance with results of an action associated with a geographic region covered by the given base station.

14. A method according to claim 13, wherein:
said location-specific information comprises locations-specific advertising information supplied by a winning bidder of the auction.

15. A system for communicating information in a cellular network comprising:
a plurality of base stations each including means for bidirectional wireless communication with a plurality of mobile units located within a respective coverage area adjacent thereto; and
a plurality of interfaces, each associated with a respective base station, for receiving location-specific information communicated thereto;
wherein each given base station is adapted to communicate said location-specific information received at the interface associated therewith to mobile units located within a respective coverage area adjacent thereto in a wireless broadcast mode of operation; and
wherein each mobile unit of said plurality of mobile units includes
means for receiving said location-specific information communicated from respective base stations in the wireless broadcast mode of operation, and
means for updating a predetermined display area of a display window on the respective mobile unit in order to visually convey said location-specific information.

16. A system according to claim 15, further comprising:
means for dynamically updating location-specific information communicated to said plurality of interfaces.

17. A system according to claim 15, further comprising:
means for communicating said location-specific information to a group of said interfaces, wherein each interface of the group receives said location-specific information and effectuates communication of said location-specific information from the given base station associated therewith to mobile units located within the coverage area of the given base station in a wireless broadcast mode of operation.

18. A system according to claim 15, wherein:
each respective mobile unit employs a graphical user interface comprising a logically organized hierarchy of display windows, said predetermined display area being part of said hierarchy of display windows.

19. A system according to claim 18, wherein:
said hierarchy of display windows includes a main display window that is displayed at start-up, said predetermined display area being part of said main display window.

20. A system according to claim 15, wherein:
said base stations communicate with mobile units over a plurality of wireless communication channels, wherein at least one of said wireless communication channels is assigned for communicating said location-specific information from a given base station to mobile units in the wireless broadcast mode of operation.

21. A system according to claim 20, wherein:
said base stations employ at least one of (i) code division multiple access methodology that uses orthogonal codes to implement said plurality of wireless communication channels, time division multiple access methodology that uses time division multiplexing of a frequency to implement said plurality of wireless communication channels, and (iii) frequency division multiple access methodology which uses separate frequencies to implement said plurality of wireless communication channels.

22. A system according to claim 15, further comprising:
a content source for generating said location-specific information; and
means for communicating said location-specific information from the content source to said plurality of interfaces over at least one communication network therebetween.

23. A system according to claim 22, wherein:
said communication network comprises an IP network.

24. A system according to claim 23, wherein:
said IP network includes the Internet.

25. A system according to claim 23, wherein:
said content source generates said location-specific information in accordance with results of a voting contest.

26. A system according to claim 23, wherein:
said location-specific information relates to a winner of the voting contest for a particular geographic region covered by a subset of said base stations.

27. A system according to claim 23, wherein:
said content source generates said location-specific information in accordance with results of an action associated with a geographic region covered by a subset of said base stations.

28. A system according to claim 27, wherein:
said location-specific information comprises locations-specific advertising information supplied by a winning bidder of the auction.

29. A system according to claim 27, further comprising:
means for hosting said auction and collecting bids related thereto from subscribers over a communication network.
